(19) United States
(12) Patent Application Publication
(10) Pub. No.: US 2026/0014971 A1
(43) Pub. Date: Jan. 15, 2026

(54) METHOD, CIRCUITRY, MOTOR VEHICLE OR TRAILER HAVING CIRCUITRY FOR BLEEDING A BRAKE CHANNEL OF A COMPRESSED-AIR BRAKING SYSTEM

(71) Applicant: ZF CV Systems Europe BV, Brussels (BE)

(72) Inventors: Andreas Peters, Obernkirchen (DE); Arnin Sieker, Bielefeld (DE); Karsten-Wilhelm Lüchau, Lachendorf (DE); Axel Stender, Hameln (DE)

(21) Appl. No.: 19/337,614

(22) Filed: Sep. 23, 2025

Related U.S. Application Data
(63) Continuation of application No. PCT/EP2024/055107, filed on Feb. 28, 2024.

(30) Foreign Application Priority Data
Mar. 23, 2023 (DE) 10 2023 107 291.9

(51) Int. Cl. B60T 13/66; B60T 7/20; B60T 8/17; B60T 8/171; B60T 8/172; B60T 8/32; B60T 8/58; B60T 13/26; B60T 13/36; B60T 13/68; B60T 17/00

(52) U.S. Cl. CPC B60T 13/662; B60T 7/20; B60T 8/1708; B60T 8/171; B60T 8/172; B60T 8/323; B60T 8/58; B60T 13/268; B60T 13/36; B60T 13/683; B60T 17/008; B60T 8/327; B60T 2220/04; B60T 2250/04; B60T 2260/08

(57) ABSTRACT

Via a method for venting at least one brake channel in a brake circuit of a compressed-air brake system of a vehicle, the brake channel can be vented. The compressed-air brake system has a brake pressure modulator that includes switchable valves for a control pressure. The brake system has an electronic control device interacting with the modulator. The modulator has, for each brake channel, at least one relay valve via which, firstly, a quantity of air can be introduced into at least one brake cylinder for actuating the brake and, secondly, the brake cylinder can be vented. During the venting operation, an adjustment to a setpoint pressure target is implemented. A setpoint pressure gradient during the venting operation is changed, in a manner dependent upon the pressure in the brake cylinder and on the operating state of the vehicle, in accordance with an algorithm stored in the control unit.

### CROSS-REFERENCE TO RELATED APPLICATIONS

This application is a continuation application of international patent application PCT/EP2024/055107, filed Feb. 28, 2024, designating the United States and claiming priority from German application 10 2023 107 291.9, filed Mar. 23, 2023, and the entire content of both applications is incorporated herein by reference.

### TECHNICAL FIELD

The disclosure relates to a method for venting at least one brake channel in a brake circuit of a compressed-air brake system of a vehicle, wherein the compressed-air brake system has a brake pressure modulator including a plurality of switchable valves for a control pressure, includes an electronic control device interacting with the brake pressure modulator, includes one or more brake cylinders acting on a wheel brake, and includes one or more pressure sensors, wherein the brake pressure modulator has, for each brake channel, at least one relay valve via which, firstly, a quantity of air can be introduced from a supply pressure line, which is independent of the control pressure, into at least one brake cylinder for the purposes of actuating the brake and, secondly, the brake cylinder can be vented via a venting outlet of the relay valve, wherein, during the venting operation, an adjustment to a setpoint pressure specification is implemented through the switching of one or more valves of the brake pressure modulator. Also disclosed are an electropneumatic circuit arrangement for carrying out the method, and a vehicle having such a circuit arrangement.

### BACKGROUND

With ever-increasing transport volumes, transport operations carried out using utility vehicles are also significantly increasing. Operating noises of auxiliary units and system devices are thus also becoming more conspicuous and do not merely occur occasionally in the background at loading stations or in parking facilities. These noises are perceived to be unpleasant and disturbing not only by the vehicle occupants but also and particularly by people in the surroundings.

For example, venting operations in a compressed-air brake system of a vehicle are associated with significant noise emissions and would place a particular burden on the environment if not remedied via corresponding measures, for example via silencers at the cross section where the compressed air emerges into the surroundings. This applies in particular to the venting of brake systems at low speeds and during maneuvering operations, where correspondingly large silencers are required.

Such silencers are additional components in a compressed-air brake system, which must be configured in accordance with the flow and pressure conditions for any sudden venting of a brake system. Different configurations of silencers exhibit different levels of suitability for reducing the sound emissions that occur during a venting operation, as disclosed for example in DE 10 2013 016 086 A1 or DE 10 2009 029 968 A1. In any case, the installation of correspondingly dimensioned silencers configured for the particular brake system requires associated structural space in the vehicle, the silencer being an element that entails additional costs both in terms of assembly and in terms of production.

### SUMMARY

It is an object of the present disclosure to provide a method and an electropneumatic circuit arrangement by which a considerable noise reduction is made possible during venting operations in compressed-air brake systems of vehicles.

The object is achieved via various embodiments of the disclosure.

Here, a setpoint pressure gradient during the venting operation is changed, in a manner dependent on the pressure in the brake cylinder and on the operating state of the vehicle, in accordance with an algorithm stored in the control unit.

A setpoint pressure specification is provided for the control of the venting operation. The setpoint pressure gradient indicates the pressure drop per unit of time with which the pressure in the system/venting pressure is vented to the atmosphere.

If, as has hitherto been the case in the prior art, the switching of the relay valve provided for the venting operation is controlled only on the basis of the setpoint pressure specification, then, depending on the flow profile or line conditions during the venting operation and in general, the resulting setpoint pressure gradient is such that abrupt venting leads to an outflow associated with increased noise emissions. The sound pressure at the start of the venting operation is thus particularly high.

The method according to the disclosure now involves different control of the venting operation, wherein, specifically, the relay valve provided for the venting operation is actuated such that the setpoint pressure gradient during the venting operation is changed, namely in a manner dependent on the pressure in the brake cylinder and on the operating state of the vehicle. This firstly prevents a steep rise of the sound pressure, and the extreme formation of a sound pressure peak, at the start of the venting process. The change of the setpoint pressure gradient is implemented by virtue of particular valves in the electropneumatic circuit arrangement being switchable in pulsed and stepped fashion such that a venting volume flow can be changed via the control chamber of the relay valve.

Through the use of methods according to the disclosure during the venting operation, it is possible for a silencer to be produced much more easily and also significantly reduced in terms of its dimensions, such that, overall, structural space and costs can be saved.

In an embodiment of the method, the change consists in a reduction of the setpoint pressure gradient. The sound pressure at the start of the venting operation is thus particularly effectively reduced.

A further embodiment includes that the change of the setpoint pressure gradient is implemented only below a specified traveling speed of the vehicle, preferably only below 15 km/h. The anti-lock brake system (ABS) provided in utility vehicles becomes active above 15 km/h. The ABS controller however also requires occasional abrupt venting for safety reasons, without regard being given to noise emissions. Since the algorithm that controls the venting intervenes only below 15 km/h, control conflicts between the method according to the disclosure and the ABS controller are thus avoided.

Control conflicts are also avoided via a further embodiment of the method which includes that the change of the setpoint pressure gradient is implemented only if no vehicle-safety or driver-assistance system routine involving the control unit of the compressed-air brake system is simultaneously being performed in a vehicle controller.

A further embodiment of the method includes that the setpoint pressure gradient is reduced at least over individual time segments during the venting time. It can thus be achieved, as already presented above, that a steep rise of the sound pressure at the start of the venting process is prevented, and the setpoint pressure gradient and thus also the venting cross section can be increased again toward the end of the venting process.

A further embodiment of the method includes that at least two brake channels of a compressed-air brake system of a vehicle are vented alternately, wherein, depending on the embodiment of the compressed-air brake system and of the brake channels, the venting may take place either on alternate sides and/or on alternate axles.

A further embodiment includes that the method according to the disclosure is used for venting at least one service brake circuit and/or at least one parking brake circuit of a compressed-air brake system of a vehicle.

One embodiment of the method includes that at least one brake circuit of a compressed-air brake system of a trailer of a towing vehicle and/or at least one brake circuit of a compressed-air brake system of a towing vehicle are vented.

Through the use of the method according to the disclosure for a plurality of brake channels, for different brake circuits and for brake channels or brake circuits of a trailer and a towing vehicle, the method can be used in a highly variable manner, leading to an extensive noise reduction during venting in vehicles of a wide variety of different configurations.

An electropneumatic circuit arrangement, which is particularly suitable for carrying out the method according to the disclosure, of a compressed-air brake system will be presented in more detail on the basis of an embodiment.

### BRIEF DESCRIPTION OF DRAWINGS

The invention will now be described with reference to the drawings wherein:

FIG. 1 shows an electropneumatic circuit arrangement for carrying out the method according to the disclosure; and,

FIG. 2 shows a diagram for the comparison of the sound pressure curve and the brake pressure curve during conventional venting operations according to the prior art and when using the method according to the disclosure.

### DETAILED DESCRIPTION

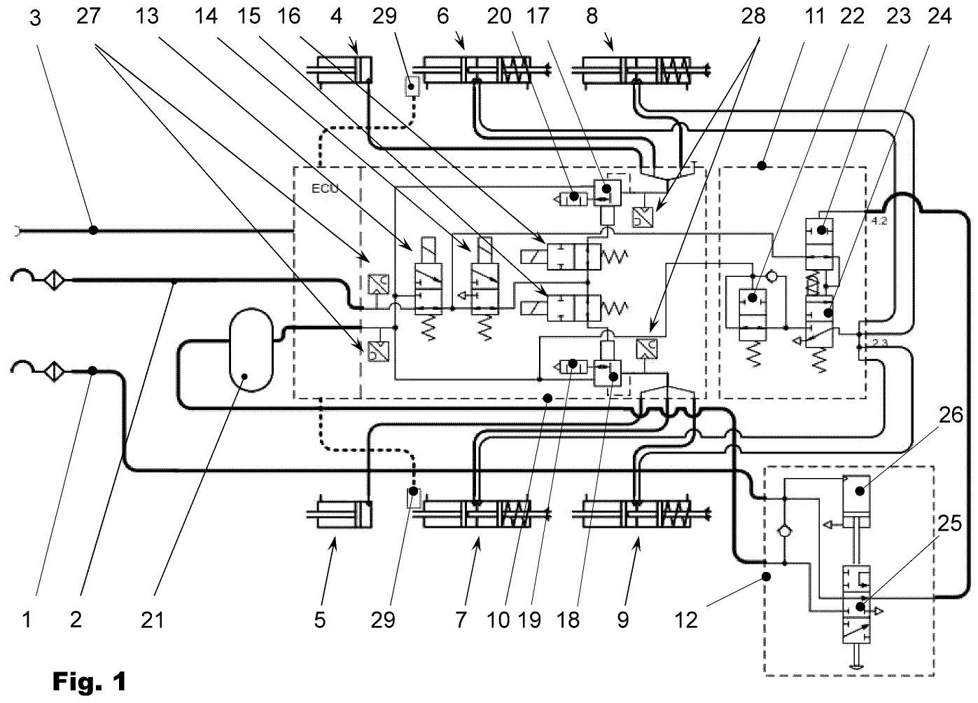

FIG. 1 shows a detail, which is of relevance to the method according to the disclosure and the associated electropneumatic circuit arrangement, from the circuit arrangement of a compressed-air brake system of a vehicle, specifically the electropneumatic circuit diagram of a trailer of a utility vehicle.

A central element of the electropneumatic circuit arrangement shown here is the brake pressure modulator 10, which has an arrangement of pneumatic elements and sensors and has an electronic control device (Electronic Control Unit, ECU) that interacts with the brake pressure modulator. Illustrated as belonging to the brake pressure modulator in FIG. 1 are the redundancy valve 13, the outlet valve 14 and the inlet valves 15 and 16, and also the relay valves 17 and 18, which are actuated by a control pressure prevailing in their control chambers. Also shown are the venting outlets, each equipped with silencers 19, 20, of the relay valves; the pressure sensors 27 and 28 at various measurement points; and the rotational speed sensors 29 at the two wheels of an axle. The brake pressure modulator and ECU are enclosed in FIG. 1 by a dashed line.

Also enclosed by a dashed line are further important functional units of a trailer compressed-air brake system, namely an emergency brake valve with overload protection as a functional unit 11, and a parking/release valve as a functional unit 12. The functional unit 11 includes a switchable check valve 22, an overload protection valve 23 and an emergency brake valve 24. The functional unit 12 has a manually actuatable 4/3 directional valve 25 and has a pneumatic restoring means 26.

The functional units 11 and 12 are however not essential in the context of the method according to the disclosure, and will therefore also not be described in any more detail here in terms of their individual circuit arrangements and functions.

FIG. 1 also shows a supply pressure line 1, which also fills the reservoir pressure vessel 21; a control pressure line 2; and a voltage supply 3 for the ECU.

Finally, the actuating devices of the brake system are illustrated, namely the service brake cylinders 4 and 5 and the double diaphragm cylinders 6, 7, 8 and 9.

In principle, during electropneumatic control of a compressed-air brake system, the control pressure in the control line, which substantially represents a “driver demand”, is combined with or superposed on a control characteristic that is specified in the control electronics. The control pressure, also referred to as redundancy pressure, corresponds to the pressure that a driver generates by applying pressure to a brake pedal.

In the case of venting as a result of an abrupt reduction in control pressure, for example if the driver suddenly lifts their foot from the brake pedal following a prior brake actuation, the pressure in the control line 2 abruptly falls, for example from 8 bar to 1 bar.

A pressure sensor 27 that measures the pressure in the control line registers the sudden pressure drop and initiates a corresponding reaction in the electronics, which then likewise operate so as to implement a rapid pressure reduction. While the valves 15 and 16 remain, for this purpose, in the deenergized position illustrated in FIG. 1, the control device energizes and switches the solenoid valve 14, by which the line leading to the control chambers of the relay valves 17 and 18 is then connected to atmospheric pressure. The control chambers of the relay valves 17 and 18 are then vented.

When their control chambers are vented, the relay valves 17 and 18 vent the service brake cylinders 4 and 5 and the double diaphragm brake cylinders 6, 7, 8 and 9. During the prior brake actuation, these brake cylinders were indeed filled, via the relay valves, with a relatively large quantity of air from the supply pressure or the pressure accumulator. The brake cylinders 4 to 9 are then likewise vented via the relay valves 17, 18, and the outlet thereof, to the silencers 19 and 20 and directly into the atmosphere.

In the event of such a sudden pressure drop in the control line, that is, if the driver suddenly lifts their foot from the brake pedal, the method according to the disclosure then takes effect. Specifically, the brake cylinders 4 to 9 are then vented not as abruptly as specified by the driver but in a manner specified by the electronic controller. A corresponding algorithm is stored in the electronic controller for this purpose.

Here, the pressure in the control chambers of the relay valves is controlled such that, during the venting of the brake cylinders that takes place through the relay valves, the pressure gradient, that is, the gradient of the pressure drop during the venting operation, is controlled in a manner dependent on the brake pressure in the brake cylinders. Here, the brake pressure in the brake cylinders is detected via one of the pressure-measuring sensors 28.

The change in the pressure gradient is implemented via a change in the volume flow in the relay valves during the venting operation, specifically by virtue of the valves being opened in specified pulsed or stepped fashion, in accordance with the brake pressure, in a manner specified by the algorithm in the control device. Since the relay valves 17 and 18 operate in pressure-controlled fashion, the pulsed or stepped opening is effected via the electronic control device through corresponding pulsed and stepped switching of the venting valve 14 and of the inlet valves 15 and 16.

The venting of the brake cylinders is thus performed in a manner dependent on the brake pressure in the brake cylinders, not only in a manner dependent on the brake pressure in the control pressure line 2 as specified by the driver. This is additionally performed in a manner dependent on the speed and on the presence of higher-level control strategies, for example only in the absence of an intervention by an ABS controller.

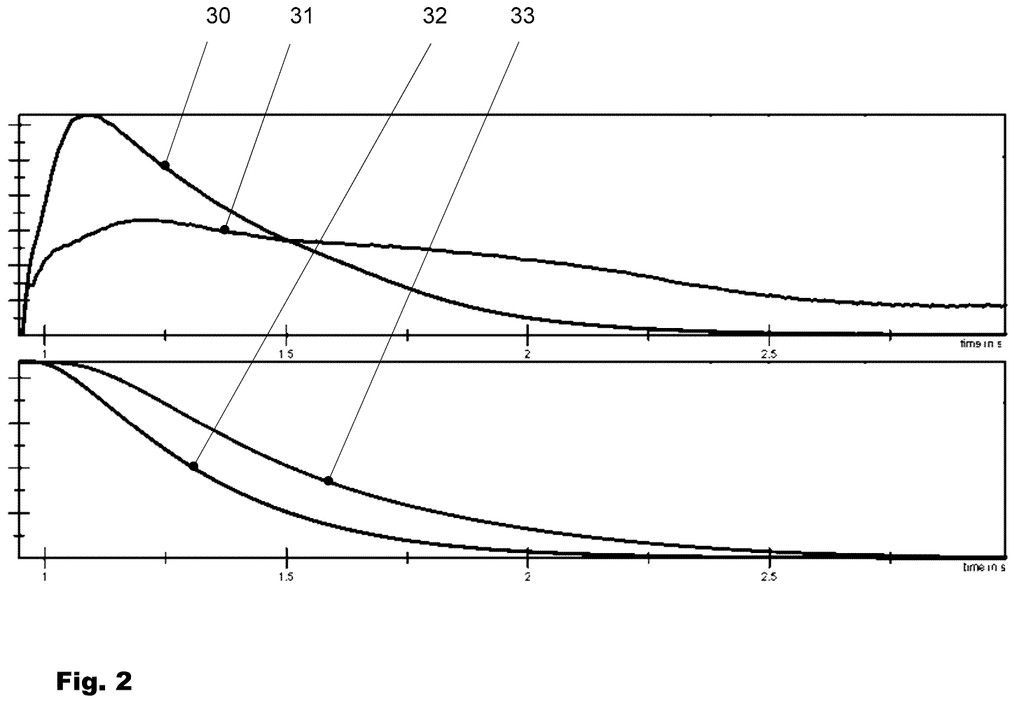

FIG. 2, in the form of a comparison diagram, shows the sound pressure curve in accordance with ECE-R 51 (Regulation No. 51 of the Economic Commission for Europe of the United Nations) and the brake pressure curve during conventional venting operations according to the prior art and when using the method according to the disclosure.

The sound pressure curves 30 and 31 are plotted in the upper part of the diagram. Curve 30 shows the sound pressure profile in Pa (A) versus the venting time according to the conventional methods in the prior art, and curve 31 shows the sound pressure profile versus the venting time according to the method according to the disclosure. The method according to the disclosure is approximately 6 dB (A) quieter than the venting known from the prior art.

In the lower part of the diagram, the brake pressure is plotted versus the venting time. It can be clearly seen from the curve 32 that, in the case of the venting method in the prior art, the brake pressure falls with a very much higher gradient, that is, much more steeply, than the brake pressure in the case of the method according to the disclosure, as illustrated by the curve 32.

It is understood that the foregoing description is that of the preferred embodiments of the invention and that various changes and modifications may be made thereto without departing from the spirit and scope of the invention as defined in the appended claims.

### LIST OF REFERENCE SIGNS (PART OF THE DESCRIPTION)

1 Supply pressure line/supply pressure circuit
2 Control pressure line/control pressure circuit
3 Voltage supply
4, 5 Service brake cylinder
6-9 Double diaphragm cylinder
10 Brake pressure modulator
11 Functional unit: emergency brake valve with overload protection
12 Functional unit: parking/release valve
13 Redundancy valve
14 Outlet valve
15 Inlet valve
16 Inlet valve
17 Relay valve
18 Relay valve
19 Silencer/venting outlet
20 Silencer/venting outlet
21 Reservoir pressure vessel for the service brake
22 Switchable check valve
23 Overload protection valve
24 Emergency brake valve
25 Manually actuatable 4/3 directional valve
26 Pneumatic restoring means (in travel position)
27 Pressure sensor
28 Pressure sensor
29 Rotational speed sensor
30 Sound pressure curve versus venting time, according to the prior art
31 Sound pressure curve versus venting time, according to the method according to the disclosure
32 Brake pressure curve versus venting time, according to the prior art
33 Brake pressure curve versus venting time, according to the method according to the disclosure

1. A method for venting at least one brake channel in a brake circuit of a compressed-air brake system of a vehicle, wherein the compressed-air brake system includes:
a brake pressure modulator including a plurality of switchable valves for a control pressure;
an electronic control unit interacting with the brake pressure modulator;
at least one brake cylinder acting on a wheel brake as well as at least one pressure sensors;
the brake pressure modulator having, for each of the at least one brake channel, a relay valve wherethrough, firstly, a quantity of air can be introduced from a supply pressure line, which is independent of the control pressure, into at least one brake cylinder for actuating the brake and, secondly, the brake cylinder can be vented via a venting outlet of the relay valve; the method comprising:
during the venting operation, implementing an adjustment to a setpoint pressure target by the switching at least one of the valves of the brake pressure modulator; and,
changing a setpoint pressure gradient during the venting operation in a manner dependent upon the pressure in the brake cylinder and on an operating state of the vehicle in accordance with an algorithm stored in the electronic control unit.

2. The method of claim 1, wherein the change of the setpoint pressure gradient is characterized as an at least initial reduction of the setpoint pressure gradient.

3. The method of claim 1, wherein the change of the setpoint pressure gradient is implemented only below a specified traveling speed of the vehicle.

4. The method of claim 1, wherein the change of the setpoint pressure gradient is implemented only when no vehicle-safety or driver-assistance system routine involving the control unit of the compressed-air brake system is simultaneously being performed in a vehicle controller.

5. The method of claim 1, wherein the setpoint pressure gradient is reduced at least over individual time segments during the venting time.

6. The method of claim 1, wherein at least two brake channels of a compressed-air brake system of a vehicle are vented alternately.

7. The method of claim 1, wherein, the method is for at least one of the following: i) for venting at least one service brake circuit; and, ii) for venting at least one parking brake circuit of a compressed-air brake system of a vehicle.

8. The method of claim 1, wherein: i) at least one brake circuit of a compressed-air brake system of a trailer of a towing vehicle is vented; and, ii) at least one brake circuit of a compressed-air brake system of a towing vehicle is vented.

9. An electropneumatic circuit arrangement of a compressed-air brake system, the electropneumatic circuit arrangement comprising:
a control pressure circuit and a supply and reservoir pressure circuit independent of said control pressure circuit;
a brake pressure modulator including a plurality of switchable valves for the control pressure;
an electronic control unit for the switchable valves, which interacts with said brake pressure modulator;
at least one brake cylinders acting on a wheel brake;
at least one pressure sensor interacting with said electronic control unit, at different locations in said pneumatic circuit arrangement;
wherein the brake pressure modulator is assigned, for each brake channel, at least one relay valve wherethrough, firstly, a quantity of air can be introduced from a supply pressure line, which is independent of the control pressure, into at least one brake cylinder for actuating the brake and, secondly, the brake cylinder can be vented via a venting outlet of the relay valve;
wherein the relay valve is configured as a pressure-controlled valve equipped with a control chamber and has a venting outlet having a silencer; and,
said electronic control unit has programmed therein an algorithm via which a setpoint pressure gradient during the venting operation can be changed in a manner dependent on the pressure in the brake cylinder and on the operating state of a vehicle.

10. The electropneumatic circuit arrangement of claim 9, wherein at least one venting valve and at least one inlet valve for control pressure into the associated control chamber of the relay valve are provided, wherein the at least one venting valve and inlet valve are switchable in pulsed and stepped manner such that a venting volume flow in said relay valve can be changed via the control chamber of the relay valve.

11. The electropneumatic circuit arrangement of claim 9, wherein, for the measurement of the pressure in the brake cylinder, a pressure-measuring sensor is provided in the connecting line between said relay valve and said brake cylinder or in the control chamber of the relay valve.

12. A motor vehicle comprising an electropneumatic circuit arrangement of a compressed-air brake system; said electropneumatic circuit arrangement including:
a control pressure circuit and a supply and reservoir pressure circuit independent of said control pressure circuit;
a brake pressure modulator including a plurality of switchable valves for the control pressure;
an electronic control unit for the switchable valves, which interacts with said brake pressure modulator;
at least one brake cylinders acting on a wheel brake;
at least one pressure sensor interacting with said electronic control unit, at different locations in said pneumatic circuit arrangement;
wherein the brake pressure modulator is assigned, for each brake channel, at least one relay valve wherethrough, firstly, a quantity of air can be introduced from a supply pressure line, which is independent of the control pressure, into at least one brake cylinder for actuating the brake and, secondly, the brake cylinder can be vented via a venting outlet of the relay valve;
wherein the relay valve is configured as a pressure-controlled valve equipped with a control chamber and has a venting outlet having a silencer;
said electronic control unit has programmed therein an algorithm via which a setpoint pressure gradient during the venting operation can be changed in a manner dependent on the pressure in the brake cylinder and on the operating state of the vehicle.

13. A trailer for a towing vehicle having an electropneumatic circuit arrangement as claimed in claim 9.

14. The method of claim 1, wherein the change of the setpoint pressure gradient is implemented only below a specified traveling speed of the vehicle of below 15 mph.
